(19) United States
(12) Patent Application Publication
(10) Pub. No.: US 2008/0010484 A1
(43) Pub. Date: Jan. 10, 2008

(54) Storage device, storage-device management system, and storage-device management method

(75) Inventors: Mitsuhiko Ohta, Kawasaki (JP); Arata Ejiri, Kawasaki (JP); Seiji Toda, Kawasaki (JP); Yasuo Noguchi, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/899,079

(22) Filed: Sep. 4, 2007

Related U.S. Application Data
(63) Continuation of application No. PCT/JP2005/005163, filed on Mar. 22, 2005.

(51) Int. Cl. G06F 11/00

(52) U.S. Cl. 714/2

(57) ABSTRACT

A storage device includes a S.M.A.R.T. information processor that periodically diagnoses physical and functional condition of the storage device and stores diagnostic information about the condition of the storage device in a magnetic disk and a storage unit. Upon receiving a request for the diagnostic information from a host computer, the S.M.A.R.T. information processor determines whether the magnetic disk is in standby mode. The S.M.A.R.T. information processor acquires the diagnostic information from the storage unit if the magnetic disk is in standby mode, and notifies the diagnostic information to the host computer.

This is a continuation filed under 35 U.S.C. §111(a), of International Application No. PCT/JP2005/005163, filed Mar. 22, 2005.

### BACKGROUND OF THE INVENTION

1. Field of the Invention

The present invention relates to a storage device, a storage-device management system, and a storage-device management method.

2. Description of the Related Art

Prolonged use of a magnetic disk device leads to a high risk of physical failure such as damage to the disk surface or error in the signal circuit. In recent times, magnetic disk devices are equipped with a self-repairing mechanism for repairing minor defects and thereby enabling their continuous use.

Even so, as the condition of the disk surface worsens, it becomes impossible to repair the damage, which causes a sudden fatal error, i.e., crash, without any warnings. Because the crash happens suddenly, a user cannot backup data from the magnetic disk device and all the data is lost.

To avoid such a problem, some magnetic disk devices are equipped with self monitoring analysis and reporting technology (S.M.A.R.T.) that enables checking the condition of the magnetic disk devices and warning the user through a host computer about possibility of disk crash when the rate of occurrence of errors increases.

On the other hand, Japanese Patent Application Laid-Open No. 2001-266452 discloses a conventional technology in which index information of data stored in a magnetic disk is associated with operating condition of the magnetic disk, and stored in a random access memory (RAM). The information stored in the RAM is then used for efficient access to the magnetic disk data.

The magnetic disk is sometimes kept in standby mode for power saving. However, in the conventional technology, when the host computer requests for information such as rate of occurrence of errors on the magnetic disk (hereinafter, “diagnostic information”), it is necessary to activate the magnetic disk to read the diagnostic information stored in it. This is an obstacle to effectively achieving power saving.

Because the host computer frequently needs to request the magnetic disk device for the diagnostic information to enhance reliability of the data stored in the magnetic disk, it is virtually impossible to keep the magnetic disk in standby mode. Such continuous use of the magnetic disk significantly increases power consumption.

### SUMMARY OF THE INVENTION

It is an object of the present invention to at least partially solve the problems in the conventional technology.

According to an aspect of the present invention, a storage device that reads data from and writes data to a magnetic disk while rotating the magnetic disk, includes a diagnostic unit that diagnoses physical and functional condition of the storage device to acquire diagnostic information about the storage device, a storage unit that stores therein the diagnostic information, and a notification processor that receives a request for the diagnostic information, determines whether the magnetic disk is in standby mode, acquires the diagnostic information from the storage unit if the magnetic disk is in standby mode, and notifies the diagnostic information to source of the request.

According to another aspect of the present invention, a storage-device management system that manages physical and functional condition of a storage device that reads data from and writes data to a magnetic disk while rotating the magnetic disk, includes a host terminal that is configured to be connected to the storage device to read data from and write data to the storage device. The host terminal includes an acquisition unit that acquires diagnostic information on the physical and functional condition of the storage device and operational information about operating condition of the storage device, a storage unit that stores therein the diagnostic information and the operational information, and a notification unit that receives a request for the diagnostic information, determines whether the storage device is in standby mode based on the operational information, acquires the diagnostic information from the storage unit if the storage device is in standby mode, and notifies the diagnostic information to source of the request.

A storage-device management method applied to a storage device that reads data from and writes data to a magnetic disk while rotating the magnetic disk, includes diagnosing physical and functional condition of the storage device to acquire diagnostic information about the storage device, storing in a storage unit the diagnostic information, receiving a request for the diagnostic information, determining whether the magnetic disk is in standby mode, acquiring the diagnostic information from the storage unit if the magnetic disk is in standby mode, and notifying the diagnostic information to source of the request.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of a storage device according to an embodiment of the present invention;

FIG. 2 is an example of contents of a storage unit shown in FIG. 1;

FIG. 3 is a flowchart of a processing procedure performed by a S.M.A.R.T. information processor shown in FIG. 1; and

FIG. 4 is a functional block diagram of a host computer that manages diagnostic information of the storage device.

### DETAILED DESCRIPTION OF THE PREFERRED EMBODIMENTS

Exemplary embodiments of the present invention are described in detail below with reference to the accompanying drawings. The present invention is not limited to these exemplary embodiments.

The concept of a storage device according to an embodiment of the present invention is explained below. In the storage device, diagnostic information about the condition of the storage device is stored in a magnetic disk and a storage unit such as a random access memory (RAM). The diagnostic information includes such items as internal temperature of the storage device, rate of occurrence of errors in accessing (reading and writing) the magnetic disk, and seek rate and spinup time of the magnetic disk.

Upon receiving a notification request for the diagnostic information from a host computer, the storage device determines whether the magnetic disk is rotating or in standby mode for power saving. If the magnetic disk is in standby mode, the storage device acquires the diagnostic information from the storage unit, and notifies the host computer of the diagnostic information.

Therefore, even if the magnetic device is in standby mode, the storage device can notify the host computer of the diagnostic information stored in the storage unit without spinning up the magnetic disk from standby mode, thus reducing power consumption.

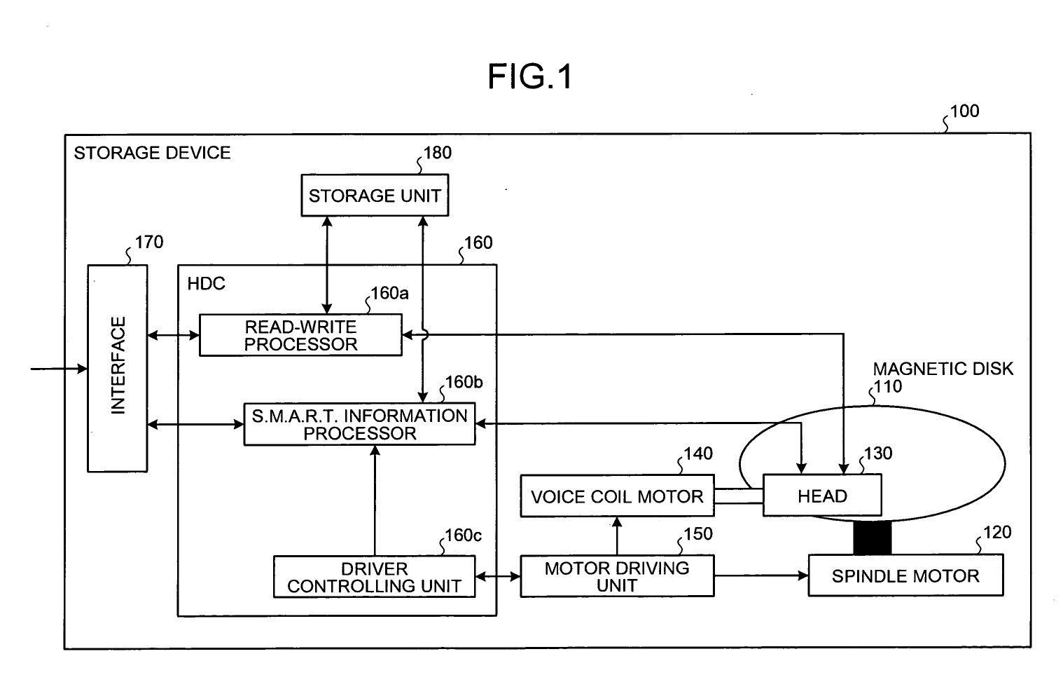

FIG. 1 is a functional block diagram of a storage device 100 according to an embodiment of the present invention. The storage device 100 includes a magnetic disk 110, a spindle motor 120, a head 130, a voice coil motor 140, a motor driving unit 150, a hard disk controller (HDC) 160, an interface 170, and a storage unit 180.

The magnetic disk 110 can be any thin disk-shaped storage medium made of resin and coated with a magnetic substance. The spindle motor 120 rotates the magnetic disk 110.

The head 130 is fixed to an arm, and performs read-write-delete operations of data on the magnetic disk 110. The voice coil motor 140 moves the head 130 to a predetermined position on the magnetic disk 110. The motor driving unit 150 operates or stops the spindle motor 120 and the voice coil motor 140.

In response to a request from a host computer (not shown), the HDC 160 diagnoses read-write operations of data, controlling of the motor driving unit 150, and rate of occurrence of errors in the storage device 100. The HDC 160 includes a read-write processor 160a, a S.M.A.R.T. information processor 160b, and a driver controlling unit 160c.

The read-write processor 160a receives data to be written to the magnetic disk 110 (write data) from the host computer through the interface 170. The read-write processor 160a temporarily stores the write data in the storage unit 180, and then writes it to the magnetic disk 110.

The interface 170 communicates with the host computer using predetermined communication protocols. The storage unit 180 receives data from the HDC 160 and stores therein the received data.

Upon receiving a read data request from the host computer through the interface 170, the read-write processor 160a reads corresponding data from the magnetic disk 110. The read-write processor 160a temporarily stores the data read from the magnetic disk 110 (read data) in the storage unit 180, and then transmits the read data to the host computer.

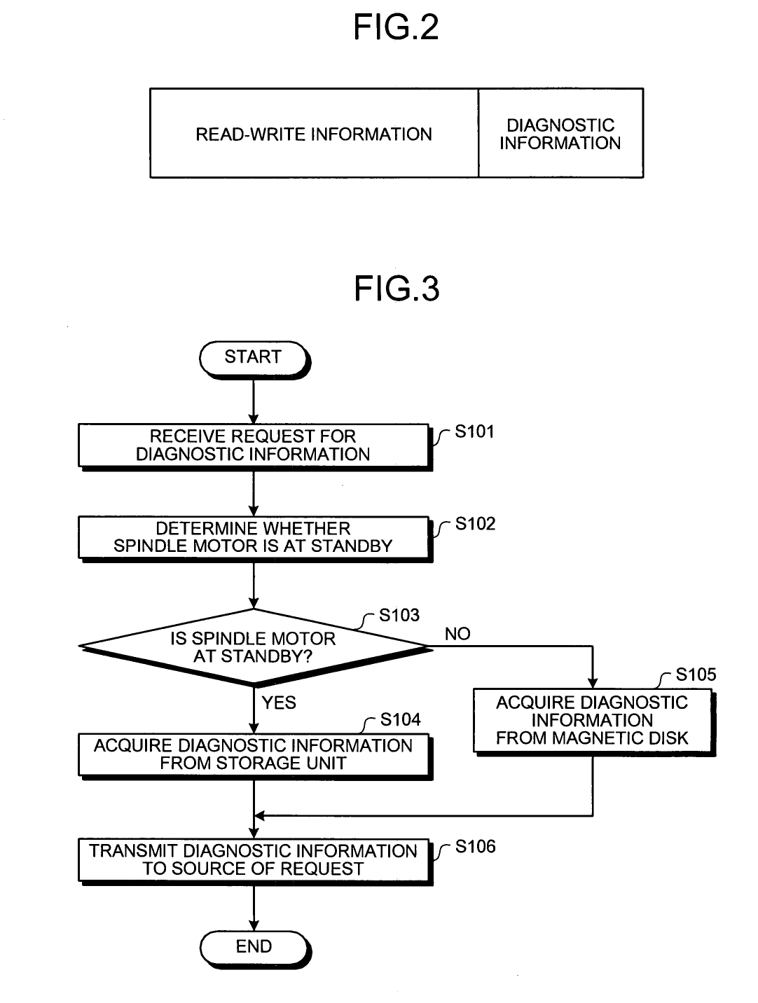

FIG. 2 is an example of contents of the storage unit 180. The storage unit 180 includes a user data area for storing the read data and the write data, and a diagnosis data area for storing the diagnostic information.

The S.M.A.R.T. information processor 160b periodically diagnoses condition of the storage device 100, and stores in the magnetic disk 110 and in the storage unit 180 the diagnostic information as a result of the diagnosis. Upon receiving a request for the diagnostic information from the host computer, the S.M.A.R.T. information processor 160b acquires the diagnostic information from the magnetic disk 110 if the magnetic disk 110 is rotating or from the storage unit 180 if the magnetic disk 110 is in standby mode, and then transmits the diagnostic information to the host computer.

To diagnose the condition of the storage device 100, the S.M.A.R.T. information processor 160b acquires information about temperature from a temperature detector (not shown), rate of occurrence of errors for read-write operations by using the head 130, and seek time and spinup time from the driver controlling unit 160c.

The driver controlling unit 160c controls the motor driving unit 150. When there is no request for read-write operations on the magnetic disk 110 for a predetermined period of time, the driver controlling unit 160c stops the spindle motor 120, so that the magnetic disk 110 enters power saving mode. The driver controlling unit 160c then notifies the S.M.A.R.T. information processor 160b that magnetic disk 110 is in the power saving mode.

The S.M.A.R.T. information processor 160b thus determines from where to acquire the diagnostic data depending on the operating condition of the magnetic disk 110. Hence, there is no need to activate the magnetic disk 110 from standby mode, and the power consumption can be efficiently reduced.

The S.M.A.R.T. information processor 160b continuously monitors the usage of data stored in the storage unit 180, and can alter the time interval for diagnosing the condition of the storage device 100 based on the data usage. When there is enough available space in the storage unit 180 (when the user data area is not in much use), the S.M.A.R.T. information processor 160b shortens the time interval for diagnosis and stores the diagnostic information in the available space.

When there is not much available space in the storage unit 180, the S.M.A.R.T. information processor 160b prolongs the time interval for diagnosis and saves the storage capacity of the storage unit 180.

The S.M.A.R.T. information processor 160b also prioritizes the items included in the diagnostic information (internal temperature of the storage device, rate of occurrence of errors in accessing the magnetic disk, and seek rate and spinup time of the magnetic disk) and stores in the storage unit 180 only items with high priority so that the storage unit 180 can be used efficiently.

A criterion for prioritization can be the number of requests the host computer makes for each item. For example, if the host computer frequently requests for information about internal temperature of the storage device 100, the S.M.A.R.T. information processor 160b sets high priority to that particular information of internal temperature of the storage device 100.

FIG. 3 is a flowchart of a processing procedure performed by the S.M.A.R.T. information processor 160b according to the embodiment. The S.M.A.R.T. information processor 160b receives from the host computer a request for the diagnostic information (step S101), and determines whether the spindle motor 120 is in standby mode (step S102).

When the spindle motor 120 is in standby mode (Yes at step S103), the S.M.A.R.T. information processor 160b acquires the diagnostic information from the storage unit 180 (step S104), and transmits the diagnostic information to the host computer (step S106).

When the spindle motor 120 is in operation (No at step S103), the S.M.A.R.T. information processor 160b acquires the diagnostic information from the magnetic disk 110 (step S105), and transmits the diagnostic information to the host computer (step S106).

In this way, the S.M.A.R.T. information processor 160b determines from where to acquire the data depending on the operating condition of the spindle motor 120, which efficiently reduces the power consumption.

As described above, according to the embodiment, the storage device 100 includes the S.M.A.R.T. information processor 160b that periodically diagnoses the condition of the storage device 100 and stores the diagnostic information in the magnetic disk 110 and in the storage unit 180. Upon receiving a request for the diagnostic information from the host computer, the S.M.A.R.T. information processor 160b acquires the diagnostic information from the magnetic disk 110 if the magnetic disk 110 is rotating or from the storage unit 180 if the magnetic disk 110 is in standby mode, and then transmits the diagnostic information to the host computer. In this way, the power consumption of the storage device 100 can be efficiently reduced.

According to the embodiment, the diagnostic information is stored in the storage unit 180 of the storage device 100. When the magnetic disk 110 is in standby mode, the diagnostic information is acquired from the storage unit 180 and transmitted to the host computer without spinning up the magnetic disk 110 from standby mode. However, the present invention is not limited to this particular embodiment. For example, the host computer can manage the diagnostic information of the storage device 100.

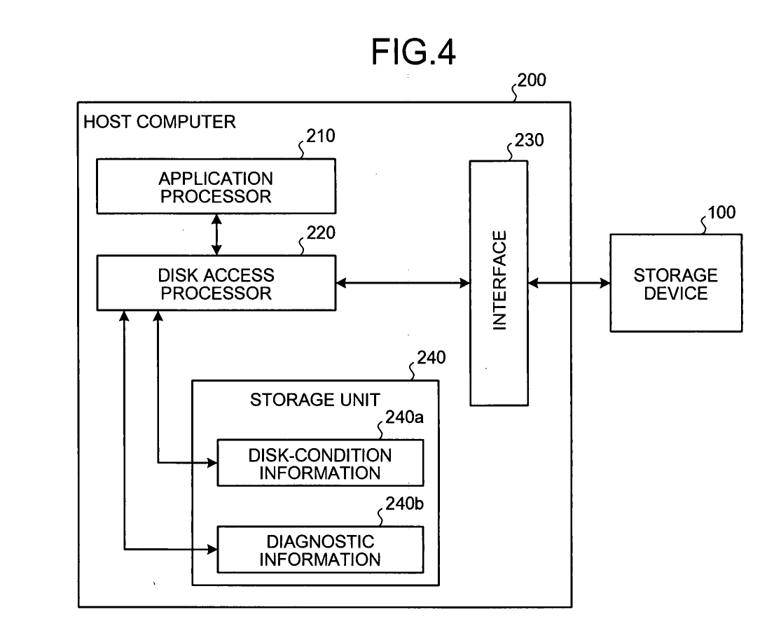

FIG. 4 is a functional block diagram of the host computer 200 that manages the diagnostic information of the storage device 100.

The host computer 200 is connected to the storage device 100 and includes an application processor 210, a disk access processor 220, an interface 230, and a storage unit 240. The application processor 210 requests the disk access processor 220 to perform read-write operations of data and acquire the diagnostic information.

Upon receiving a request from the application processor 210, the disk access processor 220 reads or writes data from or to the storage device 100. The interface 230 communicates with the storage device 100 using predetermined communication protocols.

The disk access processor 220 communicates with the storage device 100, acquires disk-condition information and the diagnostic information, and stores in the storage unit 240 the disk-condition information and the diagnostic information. The disk-condition information includes standby-mode setting information, access information, and diagnosis-timing information of the storage device 100.

The standby-mode setting information is about a time period (in hours, minutes, or seconds), after which, from the last access to the storage device 100, the storage device 100 enters standby mode. The access information is about the time of last access to the storage device 100. The diagnosis-timing information is about the time when the storage device 100 acquires the diagnostic information.

Upon receiving a request for the diagnostic information from the application processor 210, the disk access processor 220 determines, based on a disk-condition information 240a, whether the storage device 100 is in standby mode. If the storage device 100 is in standby mode, the disk access processor 220 feeds diagnostic information 240b stored in the storage unit 240 to the application processor 210. If the storage device 100 is in operation, the disk access processor 220 acquires the diagnostic information from the storage device 100 and feeds the diagnostic information to the application processor 210.

In this way, when the storage device 100 is in standby mode, the disk access processor 220 feeds the application processor 210 with the diagnostic information 240b stored in the host computer 200, thus eliminating any need to activate the storage device 100 and substantially reducing power consumption.

The host computer 200 can also be connected to the storage device 100 through a network and then manage the diagnostic information of the storage device 100.

According to an embodiment of the present invention, power consumption related to a storage device can be efficiently reduced.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A storage device that reads data from and writes data to a magnetic disk while rotating the magnetic disk, the storage device comprising:
a diagnostic unit that diagnoses physical and functional condition of the storage device to acquire diagnostic information about the storage device;
a storage unit that stores therein the diagnostic information; and
a notification processor that receives a request for the diagnostic information, determines whether the magnetic disk is in standby mode, acquires the diagnostic information from the storage unit if the magnetic disk is in standby mode, and notifies the diagnostic information to source of the request.

2. The storage device according to claim 1, wherein the diagnostic information includes internal temperature of the storage device, rate of occurrence of errors in accessing the magnetic disk, seek rate of the magnetic disk, and spinup time of the magnetic disk.

3. The storage device according to claim 1, further comprising a priority setting unit that prioritizes information items included in the diagnostic information and, when there is not sufficient space available in the storage unit, stores in the storage unit the information items in order of priority.

4. The storage device according to claim 3, wherein the priority setting unit prioritizes the information items based on contents of the request.

5. The storage device according to claim 1, wherein the diagnostic unit prolongs time interval for acquiring the diagnostic information when there is not sufficient space available in the storage unit.

6. The storage device according to claim 1, wherein the diagnostic unit shortens time interval for acquiring the diagnostic information when there is sufficient space available in the storage unit.

7. A storage-device management system that manages physical and functional condition of a storage device that reads data from and writes data to a magnetic disk while rotating the magnetic disk, the storage-device management system comprising:
a host terminal that is configured to be connected to the storage device to read data from and write data to the storage device, and includes
an acquisition unit that acquires diagnostic information on the physical and functional condition of the storage device and operational information about operating condition of the storage device;
a storage unit that stores therein the diagnostic information and the operational information; and
a notification unit that receives a request for the diagnostic information, determines whether the storage device is in standby mode based on the operational information, acquires the diagnostic information from the storage unit if the storage device is in standby mode, and notifies the diagnostic information to source of the request.

8. The storage-device management system according to claim 7, wherein the operational information includes standby-mode setting information of the storage device, access information about time when the storage device is accessed, and diagnosis-timing information about time when diagnosis of the storage device is performed.

9. A storage-device management method applied to a storage device that reads data from and writes data to a magnetic disk while rotating the magnetic disk, the storage-device management method comprising:
diagnosing physical and functional condition of the storage device to acquire diagnostic information about the storage device;
storing in a storage unit the diagnostic information;
receiving a request for the diagnostic information;
determining whether the magnetic disk is in standby mode;
acquiring the diagnostic information from the storage unit if the magnetic disk is in standby mode; and
notifying the diagnostic information to source of the request.

10. The storage-device management method according to claim 9, wherein the diagnostic information includes internal temperature of the storage device, rate of occurrence of errors in accessing the magnetic disk, seek rate of the magnetic disk, and spinup time of the magnetic disk.

11. The storage-device management method according to claim 9, wherein the storing includes prioritizing information items included in the diagnostic information and, when there is not sufficient space available in the storage unit, storing in the storage unit the information items in order of priority.

12. The storage-device management method according to claim 11, wherein the prioritizing includes prioritizing the information items based on contents of the request.

13. The storage-device management method according to claim 9, wherein the diagnosing includes prolonging time interval for acquiring the diagnostic information when there is not sufficient space available in the storage unit.

14. The storage-device management method according to claim 9, wherein the diagnosing includes shortening time interval for acquiring the diagnostic information when there is sufficient space available in the storage unit.
